(19) United States
(12) Patent Application Publication
(10) Pub. No.: US 2003/0097407 A1
(43) Pub. Date: May 22, 2003

(54) Sending voicemail messages to multiple users

(76) Inventors: Louis Robert Litwin, Plainsboro, NJ (US); John William Richardson, Hamilton, NJ (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 09/988,515

(22) Filed: Nov. 20, 2001

(51) Int. Cl. G06F 15/16; H04M 11/10

(52) U.S. Cl. 709/204; 455/413

(57) ABSTRACT

There is provided a method for sending voicemail messages to multiple recipients for instantaneous playback. An input is received that selects the multiple recipients from a stored list of users (310). Phone numbers of the multiple recipients are sent to a temporary voicemail server, in response to the receiving step (315). A voicemail message is received (320, 325). Internet Protocol (IP) addresses of the multiple recipients are determined from the phone numbers, by the temporary voicemail server (335). IP packets that include the voicemail message are sent to any of the multiple recipients that have an active mobile terminal (345). The input and the voicemail message received at the receiving steps are provided by an originating sender of the voicemail message.

### BACKGROUND

1. Technical Field

The present invention generally relates to voicemail communications and, in particular, to a method and apparatus for sending voicemail messages to multiple users.

2. Background Description

It is often useful to be able to contact multiple people simultaneously. Some simple examples would include trying to get several people together for lunch or to announce a meeting time change to an entire group of employees.

Currently people can send e-mail to multiple users simultaneously; however, they must be at a computer or a device that supports text entry. Although some mobile terminals allow text entry for e-mail, the small size of the device means that text entry is cumbersome and not as simple as speaking.

Some voicemail services do allow voicemails to be sent to other users, but the voicemails can only be forwarded to one person at a time and the user must type in each phone number for each recipient.

Accordingly, it would be desirable and highly advantageous to have a means for sending voicemail messages to multiple users.

### SUMMARY OF THE INVENTION

The problems stated above, as well as other related problems of the prior art, are solved by the present invention, a method and apparatus for sending voicemail messages to multiple users. Advantageously, the present invention allows a mobile terminal user on an all-IP (Internet Protocol) network to easily send voicemail messages (e.g., time-critical voicemail messages) to the terminals of multiple users.

According to an aspect of the present invention, there is provided a method for sending voicemail messages to multiple recipients for instantaneous playback. An input is received that selects the multiple recipients from a stored list of users. Phone numbers of the multiple recipients are sent to a temporary voicemail server, in response to the receiving step. A voicemail message is received. Internet Protocol (IP) addresses of the multiple recipients are determined from the phone numbers, by the temporary voicemail server. IP packets that include the voicemail message are sent to any of the multiple recipients that have an active mobile terminal. The input and the voicemail message received at the receiving steps are provided by an originating sender of the voicemail message.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram of a computer processing system 100 to which the present invention may be applied according to an illustrative embodiment thereof;

FIG. 2 is a block diagram illustrating a mobile communication system to which the present invention may be applied, according to an illustrative embodiment of the present invention; and

FIG. 3 is a flow diagram illustrating a method for simultaneously sending a voicemail to multiple individuals, according to an illustrative embodiment of the present invention.

### DETAILED DESCRIPTION OF PREFERRED EMBODIMENTS

The present invention is directed to a method and system for sending voicemail messages to multiple users. Advantageously, the present invention allows a mobile terminal user on an all-IP (Internet Protocol) network to easily send voicemail messages (e.g., time-critical voicemail messages) to the terminals of multiple users.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

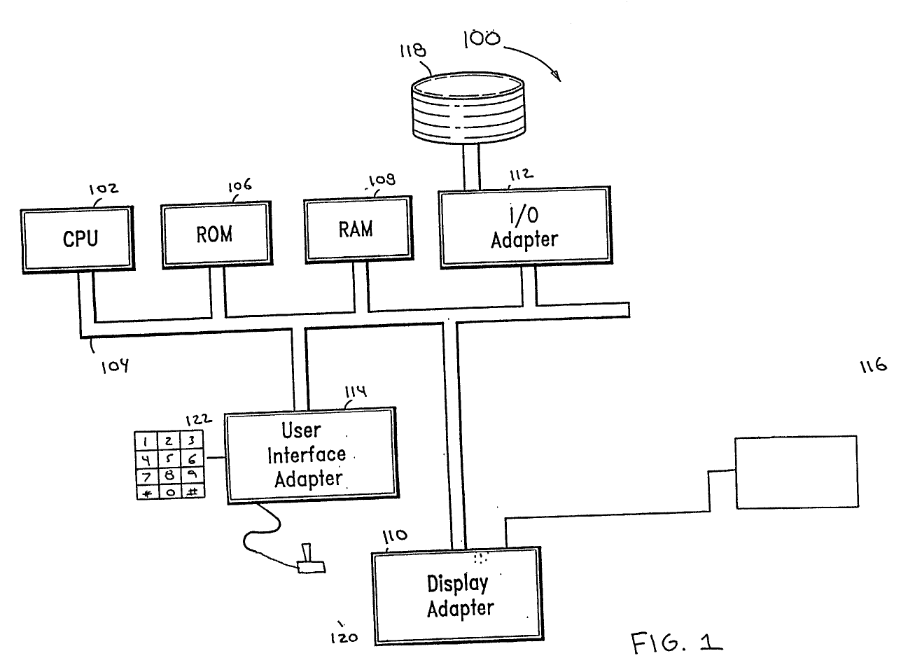

FIG. 1 is a block diagram of a computer processing system 100 to which the present invention may be applied according to an illustrative embodiment thereof. The computer processing system 100 includes at least one processor (CPU) 102 operatively coupled to other components via a system bus 104. A read only memory (ROM) 106, a random access memory (RAM) 108, a display adapter 110, an I/O adapter 112, and a user interface adapter 114 are operatively coupled to the system bus 104.

A display device 116 is operatively coupled to the system bus 104 by the display adapter 110. A disk storage device (e.g., a magnetic or optical disk storage device) 118 is operatively coupled to the system bus 104 by the I/O adapter 112.

A selection device (e.g., mouse, joystick, and so forth) 120 and keyboard 122 are operatively coupled to the system bus 104 by the user interface adapter 114. The selection device 120 and keyboard 122 may be used to input/output information to/from the computer processing system 100.

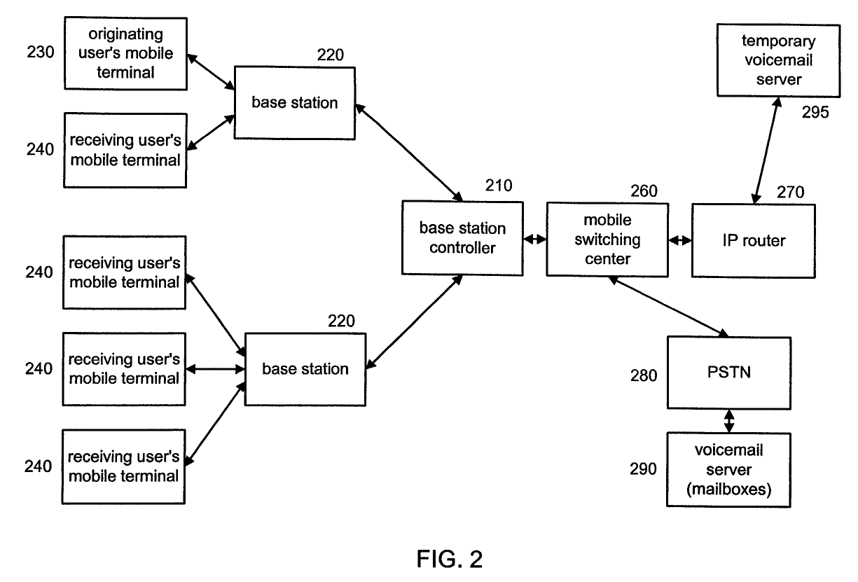

FIG. 2 is a block diagram illustrating a mobile communication system to which the present invention may be applied, according to an illustrative embodiment of the present invention. A base station controller 210 is in communication with one or more base stations (hereinafter “base stations” 220), and a mobile switching center 260. The base stations 220, in turn, are in communication with an originating user's mobile terminal (hereinafter “originating mobile terminal”) 230 and multiple receiving user's mobile terminals (hereinafter “recipients' mobile terminals”) 240.

The mobile switching center 260 is in communication with an IP router 270 and a public switched telephone network (PSTN) 280. The PSTN 280 is in communication with a “regular” voicemail server 290. The voicemail server 290 includes voicemail mailboxes. The IP router is in communication with an temporary voicemail server 295.

It is to be appreciated that the temporary voicemail server 295 includes a mapping function. The mapping function transfers to the regular voicemail server 290 an urgent voicemail that cannot be received by a recipient at a given transmission time. This may occur, for example, when the recipient's mobile terminal is not turned on or when the recipient's mobile terminal is out of the designated service area.

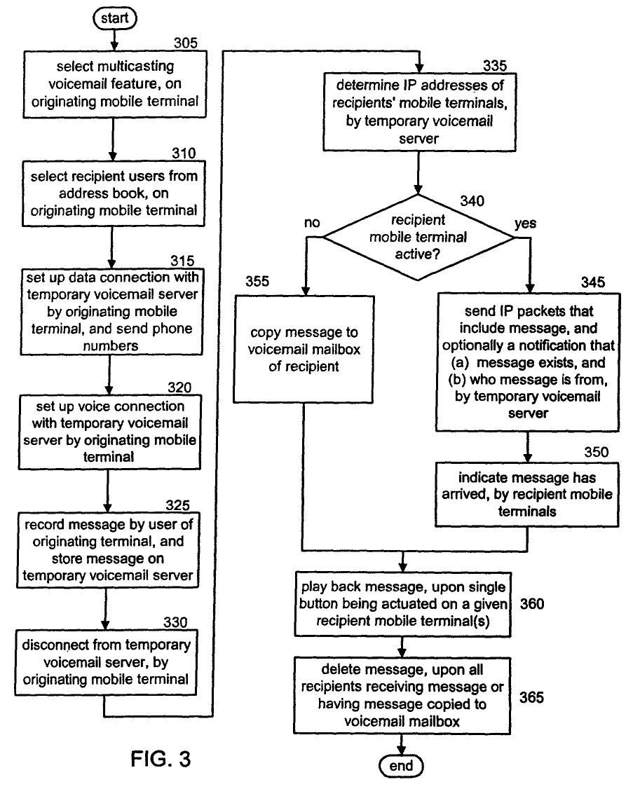

FIG. 3 is a flow diagram illustrating a method for simultaneously sending a voicemail to multiple individuals, according to an illustrative embodiment of the present invention.

A user selects a multicasting voicemail feature on his or her mobile terminal (originating mobile terminal) 230 (step 305). The user selects recipient users from an address book on his or her mobile terminal (originating mobile terminal) 230 (step 310). It is to be appreciated that step 310 is a simple step of simply highlighting each user as opposed to entering their telephone numbers.

The originating mobile terminal 230 sets up a data connection with the temporary voicemail server 295 at the service provider and the originating mobile terminal 230 provides the temporary voicemail server 295 with the user-selected recipient phone numbers (step 315). The originating mobile terminal 230 sets up a voice connection with the temporary voicemail server 295 at the service provider (step 320).

The user of the originating mobile terminal 230 records a message that is then stored digitally on the temporary voicemail server 295 (step 325). The user of the originating mobile terminal 230 disconnects from the temporary voicemail server 295 (step 330).

The temporary voicemail server 295 determines the IP addresses of the mobile terminals 240 that correspond to the recipient numbers (step 335). It is then determined, for each of the recipients of the voicemail message, whether their mobile terminal 240 is active (step 340). For each of the recipients that have an active terminal 240, the temporary voicemail server 295 sends IP packets that include the voice message to the recipients' mobile terminals 240 (step 345). Optionally, but preferably, the initial packet contains a notification message to inform the recipient's mobile terminal 240 that (a) he or she has an urgent voicemail, and (b) who the urgent voicemail is from. The recipients' mobile terminals 240 will indicate that a special voicemail has arrived (for example, with a special ring or a message) (step 350).

However, for each of the recipients that do not have an active mobile terminal 240 as determined at step 340 (e.g., because the mobile terminal 240 is not on or is out of the service area), the temporary voicemail server 295 will copy the message over to that recipient's regular voicemail mailbox 290 for later playback (step 355). Once buffering is complete, each of the multiple recipients can immediately hear the voicemail message by simply hitting a single button or other similar device on their mobile terminal (step 360). Once all the intended recipients have either received the voicemail message or have had the voicemail message copied to their voicemail mailbox, the message is deleted from the temporary voicemail server 295 (step 365).

It is to be appreciated that while the present invention has been described herein with respect to the sending of an urgent voicemail message, the present invention is equally applicable to any type of voicemail message. The important aspect is not the type of message but the fact that the message can be simultaneously sent to multiple individuals in an easy and efficient manner.

It is to be appreciated that the method of FIG. 3 is different than sending a user a regular voicemail. With standard voicemail, the user would have to call the voicemail server access number, and enter a password, and then select menu options to play a new message. According to the present invention, a voicemail message such as an urgent voicemail message appears to the user like a pre-recorded phone call that can be heard with just one push of a button.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A method for sending voicemail messages to multiple recipients for instantaneous playback, comprising the steps of:
receiving an input that selects the multiple recipients from a stored list of users (310);
sending phone numbers of the multiple recipients to a temporary voicemail server, in response to said receiving step (315);
receiving a voicemail message (320, 325);
determining Internet Protocol (IP) addresses of the multiple recipients from the phone numbers, by the temporary voicemail server (335); and
sending IP packets that include the voicemail message to any of the multiple recipients that have an active mobile terminal (345), wherein the input and the voicemail message received at said receiving steps are provided by an originating sender of the voicemail message.

2. The method of claim 1, further comprising the step of deleting the voicemail message from the temporary voicemail server after all of the multiple recipients have received the voicemail message (365).

3. The method of claim 1, further comprising the step of copying the voicemail message to a voicemail mailbox of any of the multiple recipients that do not have the active mobile terminal (355).

4. The method of claim 3, further comprising the step of deleting the message from the temporary voicemail server after all of the multiple recipients have received the voicemail message or have had the voicemail message copied to the voicemail mailbox (365).

5. The method of claim 1, wherein the IP packets further include a notification message that notifies a receiving recipient that a mobile terminal of the receiving recipient has received the voicemail message (345).

6. The method of claim 1, wherein the IP packets further include a notification message that notifies a receiving recipient of an identity of the originating sender of the voicemail message (345).

7. The method of claim 1, wherein the stored list of users is comprised in an address book stored on a mobile terminal of the originating sender (310).

8. The method of claim 1, further comprising the step of playing back the voicemail message on a mobile terminal of a given one of the multiple recipients, upon receiving an input corresponding to the given one of the multiple recipients actuating a single button (360).

9. A system for sending voicemail messages to multiple recipients for instantaneous playback, comprising:
an originating mobile terminal for receiving an input corresponding to a selection of the multiple recipients from a stored list of users, for determining phone numbers of the multiple recipients from the selection, and for receiving a voicemail message (230); and
a temporary voicemail server for receiving the phone numbers of the multiple recipients, for determining Internet Protocol (IP) addresses of the multiple recipients from the phone numbers, for temporarily storing the voicemail message, and for sending IP packets that include the voicemail message to any of the multiple recipients that have an active mobile terminal (295).

10. The system of claim 9, wherein said temporary voicemail server deletes the voicemail message after all of the multiple recipients have received the voicemail message (295).

11. The system of claim 9, further comprising a voicemail mailbox for storing the voicemail message for any of the multiple recipients that do not have the active mobile terminal (290).

12. The system of claim 11, wherein said temporary voicemail server deletes the voicemail message after all of the multiple recipients have received the voicemail message or have had the voicemail message stored to the voicemail mailbox (295).

13. The system of claim 9, wherein the IP packets further include a notification message that notifies a receiving recipient that a mobile terminal of the receiving recipient has received the voicemail message.

14. The system of claim 9, wherein the IP packets further include a notification message that notifies a receiving recipient of an identity of the originating sender of the voicemail message.

15. The system of claim 9, wherein the originating mobile terminal comprises an address book that includes the stored list of users (230).

16. The system of claim 9, further comprising a plurality of recipient mobile terminals, each of the plurality of recipient mobile terminals corresponding to one of the multiple recipients and having a single button for playing back the voicemail message (240).

17. A method for playing back a voicemail message sent to multiple recipients, comprising the steps of:
receiving an input that selects the multiple recipients from a stored list of users (310);
sending phone numbers of the multiple recipients to a temporary voicemail server, in response to said receiving step (315);
receiving a voicemail message (320, 325);
determining Internet Protocol (IP) addresses of the multiple recipients from the phone numbers, by the temporary voicemail server (335);
sending IP packets that include the voicemail message to any of the multiple recipients that have an active mobile terminal (345), wherein the input and the voicemail message received at said receiving steps are provided by an originating sender of the voicemail message; and
playing back the voicemail message on a mobile terminal of a given one of the multiple recipients, upon a single button being actuated on the mobile terminal of the given one of the multiple recipients (360).

18. The method of claim 17, further comprising the step of deleting the voicemail message from the temporary voicemail server after all of the multiple recipients have received the voicemail message (365).

19. The method of claim 17, further comprising the step of copying the voicemail message to a voicemail mailbox of any of the multiple recipients that do not have the active mobile terminal (355).

20. The method of claim 19, further comprising the step of deleting the message from the temporary voicemail server after all of the multiple recipients have received the voicemail message or have had the voicemail message copied to the voicemail mailbox (365).
